(19) United States
(12) Patent Application Publication
(10) Pub. No.: US 2003/0174068 A1
(43) Pub. Date: Sep. 18, 2003

(54) Apparatus for calibrating a digital field sensor

(76) Inventors: Jeffrey A. Dobos, Cleveland, OH (US); Stephen J. Szczecinski, Stow, OH (US); David L. Thomas, Strongsville, OH (US); Robert A. Custer, Brunswick, OH (US); Christopher J. Krempel, Cleveland, OH (US); Richard A. D'Angelo, Avon Lake, OH (US)

Correspondence Address: Mitchell Rose, Jones, Day, Reavis & Pogue, North Point, 901 Lakeside Avenue, Cleveland, OH, 44114, US

(21) Appl. No.: 10/098,844

(22) Filed: Mar. 15, 2002

(51) Int. Cl. G08C 15/06; G08C 19/22; H04Q 9/00

(52) U.S. Cl. 340/870.04; 340/870.16

(57) ABSTRACT

An apparatus for use with a digital field sensor comprises a digital communication circuit. The digital communication circuit is operative to output a digital signal indicative of calibration information for the digital field sensor. A processor is connected in operational communication to the digital communication circuit. The processor is operative to receive a value communicated to the processor by the digital field sensor. The processor is also operative to calculate calibration information based on the value and to provide the calibration information to the digital communication circuit.

### TECHNICAL FILED

The present invention relates to calibration equipment for digital field sensors.

### BACKGROUND

FIG. 1 schematically illustrates a typical application of a HART sensor 10 in a data acquisition system 12. HART sensors are used in laboratories and factories to measure a physical parameter. In this example, the parameter is air pressure in a chamber 14. An air line 16 is connected from the chamber 14 to the sensor 10 to enable the sensor 10 to determine a pressure value. The sensor 10 outputs onto a communication line 20 an analog signal indicative of the pressure value. In this example, the signal is in the form of a current loop conducted by first and second conductors 22 and 24 of the communication line 20. A host computer 26 remote from the sensor 10 is connected to the communication line 20 and monitors the analog signal. The computer 26 calculates the pressure value from the level of the analog signal.

The HART sensor is a digital field device in that it sends and receives digital signals, called HART signals, to the remote host computer 26. The HART signals are communicated over the same communication line 20 that carries the analog signal. They convey instructions and data in a format conforming to the HART protocol. For example, the sensor 10 can digitally transmit the pressure value. This is in addition to transmitting the pressure value via the analog signal.

HART sensors must be periodically calibrated to correct inaccuracy of the analog signal. For the pressure sensor 10 in this example, the calibration process entails comparing the pressure value indicated by the analog signal to the actual pressure. Using calibration equipment, a user measures the analog signal and the actual pressure, calculates from these two parameters calibration information in the form of calibration constants, and communicates the calibration information to the sensor 10.

As shown in FIG. 2, calibration equipment 30 of the prior art includes several separately-handled pieces of equipment. This equipment includes a hand pump 32, a calculator 36, a HART communicator 40, an analog signal gage 42 such as an ammeter, and a reference pressure gage 46.

The HART communicator 40 is a unitary handheld device in a handheld housing 48. It can send and receive HART signals to communicate with the HART sensor 10. Operation of the communicator 40 is controlled by a processor 50 through communication with other components of the communicator. Two of these components are a keypad 52 and a display 56 for communicating with the user. Another such component is an electrically erasable memory device 60. The processor can communicate with a computer through a serial port 62.

The communicator 40 also includes a HART communication circuit 70 for sending and receiving HART signals over the communication line 20. The communication circuit 70 interfaces between the processor 50 and the HART sensor 10, enabling the processor 50 and the sensor 10 to communicate with each other. For example, the communication circuit 70 can receive the pressure value digitally-transmitted by the HART sensor 10 for display to the user. A first pair of ports 72 of the HART communication circuit 70 are connected to a first pair of terminals 76. In turn, the terminals 76 are connectable to a first pair of connector cables 80. The cables 80 have clips 86 for clipping the cables 80 to the first and second conductors 22 and 24 of the communication line 20.

The analog signal gage 42 measures the analog signal level and displays the resulting value. The analog signal gage 42 has a second pair of terminals 96. Connected to the terminals 96 are a second pair of cables 100. The cables 100 have clips 106 for clipping the cables 100 to two ends 110 of the first conductor 22. The ends 110 are located on either side of a break 119 made in the first conductor 22.

The reference pressure gage 46 measures the pressure level and displays the resulting value. This value is considered as the actual pressure value, with reference to which the HART sensor 10 is calibrated.

A prior art calibration procedure is as follows. The connector cables 80 and 100 are connected to the communicator 40 and the communication line 20 as shown in FIG. 2. The air line 16 is reconfigured to interconnect the HART sensor 10 with the pump 32 and reference pressure gage 46.

Next, in response to a query by the communicator 40, the HART sensor 10 sends to the communicator 40 a HART signal identifying the model of the sensor 10. The communicator 40 displays instructions for the user to follow that are specific for that particular model. The instructions include specified pressure values and mathematical formulas.

In accordance with the instructions, the user does the following. By powering the hand pump 32, the user applies different pressures to the HART sensor 10 that approximately equal the specified pressures. For each applied pressure, the user records the actual pressure reading displayed by the reference pressure gage 46, the digitally-transmitted pressure value displayed by the communicator 40, and the analog reading displayed by the analog signal gage 42. From these recorded values, the user calculates the calibration information with the calculator 36 according to the specified formulas. Next, the user enters the calibration information on the keypad 52. The calibration information is sent by the communicator 40 in HART format to the HART sensor 10. The sensor 10 is thus calibrated according to the prior art.

### SUMMARY

The present invention is an apparatus for use with a digital field sensor. The apparatus comprises a digital communication circuit operative to output a digital signal indicative of calibration information for the digital field sensor. A processor is connected in operational communication to the digital communication circuit. The processor is operative to receive a value communicated to the processor by the digital field sensor. The processor is also operative to calculate calibration information based on the value and to provide the calibration information to the digital communication circuit.

In a preferred embodiment of the invention, the processor is operative to receive the value through the digital communication circuit. An AID converter is connected in operational communication to the processor. The A/D converter is operative to input an analog signal generated by the digital field sensor and to determine the value as a measure of the level of the analog signal. Furthermore, the A/D converter is operative to convey the value to the processor for the processor to calculate the calibration information based on the value.

Preferably, the apparatus further comprises a socket connected to the processor and configured for a reference sensor to be plugged into the socket. The reference sensor is operative to send through the socket to the processor a reference signal indicative of the level of a parameter sensed by the digital field sensor. This is for the processor to calculate the calibration information based on the level of the parameter as indicated by the reference sensor and the value. Another socket is connected to the processor and is configured to be connected to another reference sensor. The other reference sensor is operative to send through the socket to the processor another reference signal indicative of the level of a parameter sensed by another digital field sensor. A handheld housing contains the digital communication circuit and the processor.

In another embodiment of the invention, an electronic circuit for use with a digital field sensor comprises a digital communication circuit operative to output a digital signal indicative of calibration information for the digital field sensor. The electronic circuit also comprises an A/D converter interactive with the digital communication circuit to input an analog signal from the digital field sensor for determination of the calibration information.

In yet another embodiment of the invention, an apparatus for calibrating a digital field sensor comprises a unitary handheld device. The device is operative to measure the level of an analog signal generated by the digital field sensor, and to measure the actual level of a parameter sensed by the sensor. The device is further operative to calculate calibration information based on both the level of the analog signal and the actual level of the sensed parameter. Additionally, the device is operative to send to the sensor a digital signal indicative of the calibration information.

### BRIEF DESCRIPTION OF THE DRAWINGS

FIG. 1 is a schematic view of a data acquisition system including a HART sensor;

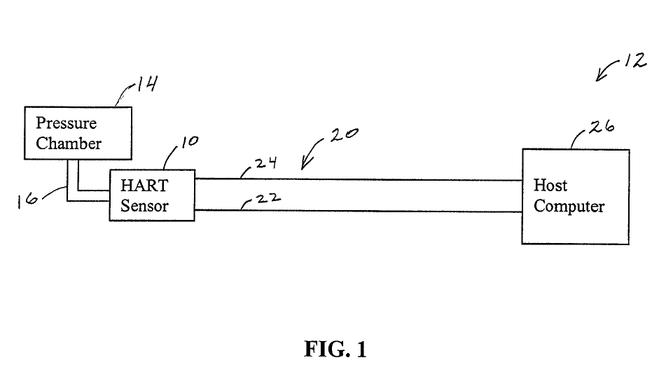

FIG. 2 is a schematic view of the data acquisition system and prior art equipment for calibrating the HART sensor;

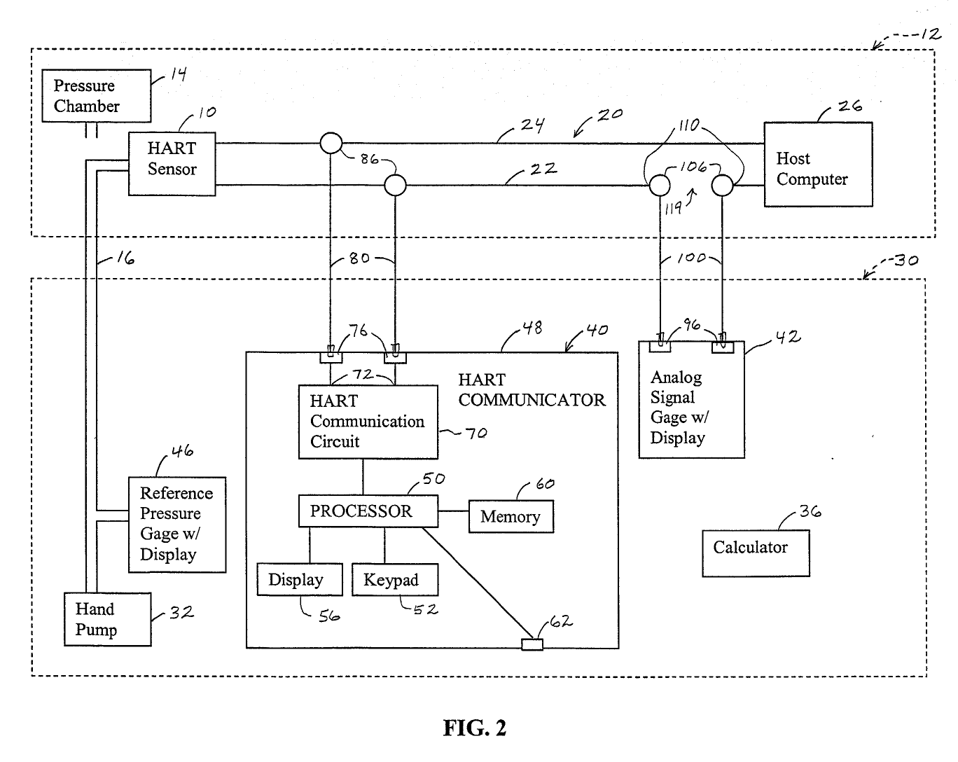

FIG. 3 is a schematic view of the data acquisition system and equipment for calibrating the HART sensor, the equipment comprising a first embodiment of the present invention; and

FIG. 4 is a schematic view of the data acquisition system and equipment for calibrating the HART sensor, the equipment comprising a second embodiment of the invention.

### DESCRIPTION

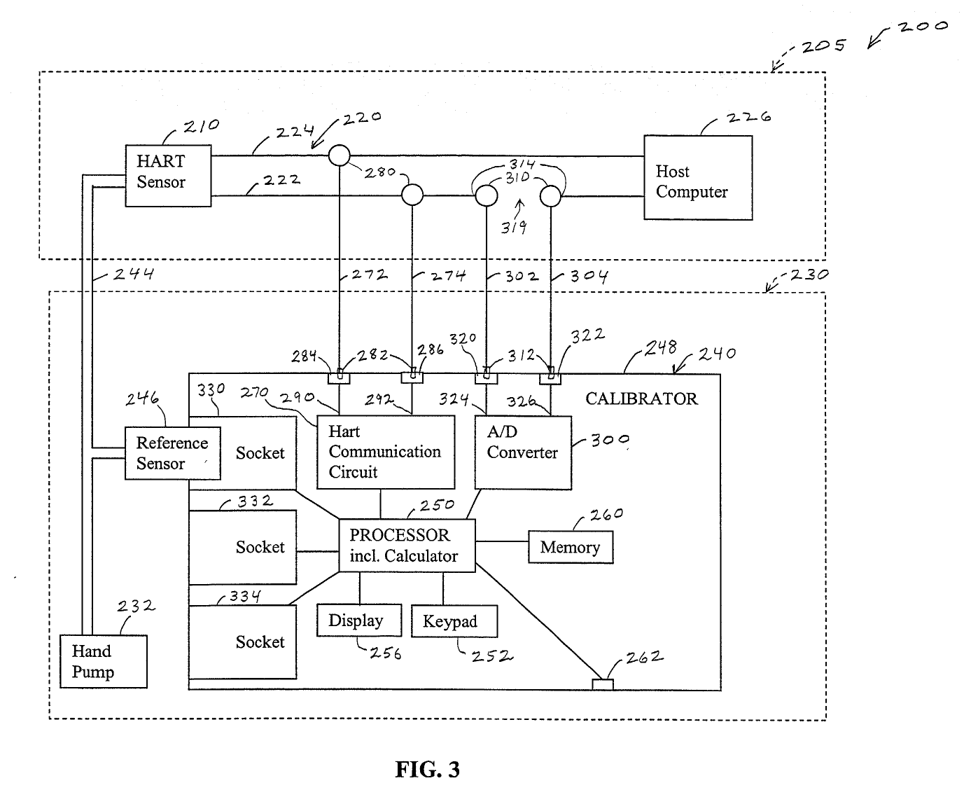

The apparatus 200 shown in FIG. 3 has parts which, as described below, are examples of the elements recited in the claims.

The apparatus 200 includes a data acquisition system 205. The system 205 includes a HART sensor 210 connected to a communication line 220 comprising first and second conductors 222 and 224. Like other sensors, the HART sensor 210 senses a physical parameter and outputs on the communication line 220 an analog signal. The level of the signal is indicative of the level of the parameter. Being also a digital field device, the HART sensor 210 also sends and receives digital signals over the communication line 220. A host computer 226 connected to the communication line 220 monitors the analog signal and determines the level of the parameter from the level of the analog signal.

The apparatus 200 also includes calibration equipment 230 for calibrating the HART sensor 210. The calibration equipment 230 includes a device 232, such as a pump, for applying a specified level of the parameter to the sensor 210 through an air line 244. According to the present invention, the calibration equipment 230 also includes a handheld calibrator 240, with a reference sensor 246 plugged into the calibrator 240. In a calibration procedure, the calibrator 240 receives signals from both the HART sensor 210 and the reference sensor 246. These signals convey data from which the calibrator 240 calculates calibration information. The calibrator 240 communicates the calibration information to the HART sensor 210 for storage by the HART sensor 210.

As mentioned above, the HART sensor 210 senses a physical parameter. In this example, the parameter is air pressure in the air line 244. The sensor 210 performs the following steps. 1) Using a first formula, the sensor 210 determines a pressure value, which is a measure of the pressure level. 2) From the pressure value, and using a second formula, the sensor 210 calculates an analog value. 3) Next, the sensor 210 outputs the analog signal with an analog level corresponding to the analog value. In this example, the analog signal is in the form of a 4-20 mA current loop. The first formula, mentioned above, is based on a first set of calibration constants. Similarly, the second formula step is based on a second set of calibration constants. These calibration constants are erasably stored in the HART sensor 210.

The HART sensor 210 can send data in digital format, specifically HART format, to the calibrator 240. It can also receive instructions in digital format from the calibrator 240 and respond accordingly. For example, the sensor will send a digital signal identifying the model of the sensor 210 when instructed to do so. Similarly, the sensor 210 will send a digital signal conveying the pressure value, i.e., the result of the first formula, when instructed to do so. Also, when instructed to do so, the sensor 210 will receive digital signals conveying the calibration information comprising one or more updated calibration constants. The sensor 210 will replace the stored calibration constants with the updated values.

The calibrator 240 is a unitary handheld device with a handheld housing 248. Operation of the calibrator 240 is controlled by a processor 250, which is in operational communication with other components of the communicator. Two of these components are a keypad 252 and a display 256 for communicating with a user.

Another of these components is an electrically erasable memory device 260. Electrically erasable memory devices, such as EEPROMs and hard drives, can erase or replace stored data if directed to do so by a processor, and retain stored data when power is removed. The memory device 260 receives and stores device description files. Each device description file contains calibration procedure information for a specific sensor model. The memory device 260 sends portions of the device description files to the processor 250 when instructed to do so by the processor 250. The device descriptions are downloaded into the memory device 260 through a serial port 262 from a computer (not shown). The computer obtains the device description files by downloading them from a compact disc distributed by the manufacturer of the calibrator 240 or from a network connection such as the internet.

The calibrator 240 further includes a digital communication circuit 270, which in this example is a HART communication circuit. This circuit 270 is connected in operational communication with the processor 250 and the communication line 220. The HART communication circuit 270 interfaces between the processor 250 and the HART sensor 210, enabling the processor 250 and the sensor 210 to communicate with each other. Specifically, the HART communication circuit 270 converts HART signals received from the sensor 210 to a format that can be received by the processor 250. Conversely, the HART communication circuit 270 converts signals from the processor 250 to HART format to the sensor 210. These digital HART signals can be indicative of, for example, the calibration information.

First and second connector cables 272 and 274 are used to connect the HART communication circuit 270 to the communication line 220. Each cable has a clip 280, preferably an alligator clip, at one end and a plug 282 at the other. The clips 280 of the first and second connector cables 272 and 274 are connected to the first and second conductors 222 and 224 of the communication line 220. The plugs 282 of the first and second cables 272 and 274 are connected to first and second terminals 284 and 286, which in this embodiment are jacks, located on the surface of the housing 248. In turn, the jacks 284 and 286 are connected to two ports 290 and 292 of the HART communication circuit 270.

An analog/digital converter 300 (A/D converter) is connected in operational communication with the processor 250 and the communication line 220. The AID converter 300 inputs from the communication line 220 the analog signals generated by the HART sensor 210. It then conveys the levels of the analog signals to the processor 250 in digital form.

Third and fourth connector cables 302 and 304 are used to connect the A/D converter 300 to the communication line 220. Each cable 302 and 304 has a clip 310 and a plug 312. The clips 310 are connected to two ends 314 of the first conductor 222. These ends are formed by a break 319 made in the first conductor 222. The plugs 312 of the third and fourth cables 302 and 304 are connected to third and fourth terminals 320 and 322, preferably jacks, located on the surface of the housing 248. In turn, the jacks 320 and 322 are connected to two ports 324 and 326 of the A/D converter 300. As will be described below, the A/D converter 300 interacts with the HART communication circuit 270 through the processor 250 to perform the calibration procedure.

As mentioned above, the reference sensor 246 is plugged into the calibrator 240. The reference sensor 246 is not a HART sensor 210, which communicates with the processor 250 through an interface 270. It rather communicates directly with the processor 250. Also, the reference sensor 246 is not hardwired in place. Rather, it is in the form of a module that is removably plugged into a socket 330 located at the surface of the housing 248. This enables the user to easily exchange the reference sensor 246 with another one that is suitable for measuring a different parameter or a different range of the same parameter. The socket 330 is connected to the processor 250, so that the reference sensor 246 can send through the socket 330 to the processor 250 the reference signal indicative of the pressure level.

The calibrator 240 has three such sockets 330, 332 and 334 into which three different reference sensors (only one being shown) can be plugged. The different reference sensors are for measuring different parameters or different ranges of the same parameter. Each reference sensor can send through the socket to the processor 250 a reference signal indicating the actual level of the corresponding parameter. This eliminates the need to swap reference sensors 246 each time a different reference sensor 246 is needed.

The handheld housing 248 contains components of the calibrator 240. These components are the processor 250, the HART communication circuit 270, the A/D converter 300, and the memory 260. They further include the serial port 262, the sockets 330, 332 and 334, and the jacks 284, 286, 320 and 322. As mentioned above, the reference sensor 246 is plugged into the calibrator 240. The calibrator 240 and the reference sensor 246 together thus comprise a unitary handheld device.

The processor 250 is programmed to perform the following steps in a calibration procedure. The steps are not necessarily performed in the following order, and some steps may be performed more than once. The steps are: 1) instructing the HART sensor 210 to send a digital signal identifying the model of the sensor 210; 2) receiving the digital signal identifying the model; 3) retrieving from the memory device 260 instructions from the device description file corresponding to that model; 4) in accordance with the instructions, directing the user via the display to apply specified pressures to the HART sensor 210; 5) continuously reading the actual pressure level from reference sensor 246 and displaying the actual pressure level, for the user to know when an applied pressure approximating the specified pressure has been attained; 6) waiting for a prompt by the user via the keypad 252 before starting step 7, the prompt indicating that the applied pressure has been attained; 7) receiving and recording the digitally-transmitted pressure value from the HART sensor 210; 8) receiving and recording the actual pressure value from the reference sensor 246; 9) calculating, from both the digitally-transmitted pressure value and the actual pressure value, calibration information comprising the first set of calibration constants; 10) providing the first set of calibration constants to the HART sensor 210 via the HART communication circuit 270 for storage by the HART sensor 210; 11) instructing the HART sensor 210 to output analog signal levels specified by the device description file; 12) receiving and recording the analog signal level actually output by the HART sensor 210, as indicated by the A/D converter 326; 13) calculating, from both the signal level specified and the signal level actually output, calibration information comprising the second set of calibration constants; and 14) providing the second set of calibration constants to the HART sensor 210 via the HART communication circuit 270 for storage by the HART sensor 210.

Steps 7 and 12 above are similar. In both steps, the processor 250 receives a value communicated by the HART sensor 210. This enables the processor 250, in following steps, to calculate calibration information based on the values and to provide that calibration information to the HART sensor 210. However, the steps differ in the following way. In step 7, the processor 250 receives the value through the HART communication circuit 270. In contrast, in step 12, the processor 250 receives the value through the A/D converter 300.

Steps 9 and 13 both entail calculating calibration information. Each device description file in memory includes a pair of formulas for use in these calculations. The pair of formulas is specific for the particular sensor model relating to that device description file. The processor 250 is informed of which device description file to use, and thus what pair of formulas to use, by the HART sensor 210 identifying its model in step 2. The formulas are thus indicated to the processor 250 by the HART sensor 210 itself.

A calibration procedure according to the invention is as follows. In this procedure, the HART sensor 210 is calibrated without removing it from its location or disconnecting it from its power lines and its communication line 220. The user connects the cables 272, 274, 302 and 304 from the calibrator 240 to the communication line 220 as shown in FIG. 3. The user also connects the air line 244 from the HART sensor 210 to the reference sensor 246 and the hand pump 232. Next, the processor 250 performs the steps enumerated above. As directed by the calibrator 240 in step 4, the user uses the pump 232 to apply different pressures that approximate the pressures specified by the calibrator 240. In accordance with step 6 above, the user prompts the calibrator 240 via the keypad 252 when each applied pressure is attained.

In the remaining steps, steps 7-14, the calibrator 240 records values, calculates calibration information and conveys it to the sensor 210. This is done in two stages. In a first stage, comprising steps 7-10, for each pressure level specified, the calibrator 240 records both the digitally-transmitted pressure value and the actual pressure value. From these values, the first set of calibration constants are calculated and conveyed to the HART sensor 210. In a second stage, comprising steps 11-14, for each signal level specified, the calibrator 240 records the signal level actually output. From the level specified and the level actually output, the second set of calibration constants are calculated and conveyed to the HART sensor 210. When the 14 procedural steps are completed, the user disconnects the cables 272, 274, 302 and 304 and reconnects the ends 314 of the communication line 220 together.

As described above, the processor 250 is configured to perform a two-stage calibration procedure. The processor 250 is further configured to alternatively perform a one-stage calibration procedure. The one-stage procedure comprises steps 1-6 above. It further comprises the following steps: 7′) receiving and recording the analog signal level output by the sensor 210 as a measure of the pressure level, the signal level being indicated by the A/D converter 300; 8′) receiving and recording the actual pressure value, as indicated by the reference sensor 246; 9′) calculating, from both the actual pressure level and the analog signal level, calibration information comprising a third set of calibration constants; and 10′) providing the third set of calibration constants to the HART sensor 210 via the HART communication circuit 270 for storage by the HART sensor 210. The HART sensor 210 can store this third set of calibration constants in place of the first calibration constant.

The functional difference between the first and third set of calibration constants are as follows. The first set of calibration constants is calculated to ensure the accuracy of the digitally-transmitted pressure value relative to the actual pressure level. In contrast, the third set of calibration constants is calculated to ensure the accuracy of the analog output level relative to the actual pressure level.

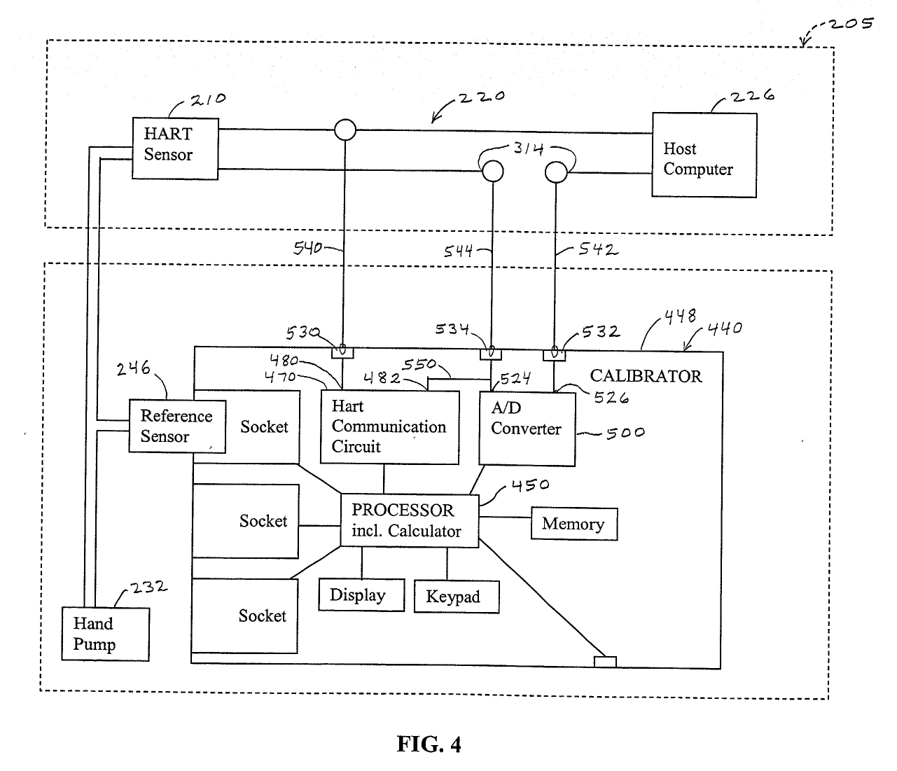

In a second embodiment of the invention, shown in FIG. 4, a calibrator 440 is connected to the data acquisition system 205 of the first embodiment. The calibrator 440 of FIG. 4 is similar to the calibrator 240 of FIG. 3. For example, the calibrator 440 of FIG. 4 has a housing 448 and a processor 450. It further has a HART communication circuit 470 with first and second ports 480 and 482. It also has an AID converter 500 with first and second ports 524 and 526. In fact, the calibrator 440 of FIG. 4 performs the same calibration function in the same way as the calibrator 240 of FIG. 3.

However, in contrast to the calibrator 240 of FIG. 3, the calibrator 440 of the FIG. 4 has only three terminals. Specifically, a first terminal 530 is connected to the digital communication circuit 470. A second terminal 532 is connected to the A/D converter 500. A third terminal 534 is electrically connected within the housing 448 to both the digital communication circuit 470 and the A/D converter 500 by means of a shunt 550. In contrast to the first embodiment, the second embodiment has only three connector cables, specifically first, second and third connector cables 540, 542 and 544. They are plugged into the first, second and third terminals 530, 532 and 534. The first cable 540 is clipped to the second conductor 224. The second and third cables 542 and 544 are clipped to the two ends 314 of the first conductor 222.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An apparatus for use with a digital field sensor, said apparatus comprising:
a digital communication circuit operative to output a digital signal indicative of calibration information for the digital field sensor; and
a processor connected in operational communication to said digital communication circuit, said processor being operative to receive a value communicated to said processor by the digital field sensor, to calculate calibration information based on said value and to provide said calibration information to said digital communication circuit.

2. An apparatus as defined in claim 1 wherein said processor is operative to receive said value through said digital communication circuit.

3. An apparatus as defined in claim 1 wherein said processor is operative to receive said value through an A/D converter.

4. An apparatus as defined in claim 1 wherein said processor is operative to calculate the calibration information based on a formula indicated to said processor by the digital field sensor.

5. An apparatus as defined in claim 1 further comprising an A/D converter connected in operational communication to said processor, said A/D converter being operative to input an analog signal generated by the digital field sensor, to determine said value as a measure of the level of the analog signal, and to convey said value to said processor for said processor to calculate said calibration information based on said value.

6. An apparatus as defined in claim 5 wherein said apparatus is operative to instruct the sensor to generate the analog signal with a specified analog level, for said processor to calculate said calibration information based on both the specified analog level and said value.

7. An apparatus as defined in claim 5 further comprising a reference sensor in operational communication with said processor and operative to send to said processor a reference signal indicative of the level of a parameter sensed by the digital field sensor, for said processor to calculate said calibration information based on both the level of the parameter as indicated by said reference sensor and said value.

8. An apparatus as defined in claim 5 further comprising a socket connected to said processor and configured for a reference sensor to be plugged into said socket, the reference sensor being operative to send through said socket to said processor a reference signal indicative of the level of the parameter, for said processor to calculate said calibration information based on both the level of the parameter as indicated by said reference sensor and said value.

9. An apparatus as defined in claim 8 further comprising a handheld housing containing said digital communication circuit, said processor, said A/D converter and said socket.

10. An apparatus as defined in claim 9 further comprising first, second and third terminals attached to said housing and configured to be connected through three respective cables to a communication line of said digital field sensor, said first terminal being electrically connected to said digital communication circuit, said second terminal being electrically connected to said A/D converter, and said third terminal being electrically connected within said housing to both said digital communication circuit and said A/D converter.

11. An apparatus as defined in claim 1 further comprising a socket connected to said processor and configured for a reference sensor to be plugged into said socket, the reference sensor being operative to send through said socket to said processor a reference signal indicative of the level of a parameter sensed by the digital field sensor, for said processor to calculate said calibration information based on the level of the parameter as indicated by said reference sensor and said value.

12. An apparatus as defined in claim 11 further comprising another socket connected to said processor and configured to be connected to another reference sensor, the other reference sensor being operative to send through the socket to the processor another reference signal indicative of the level of a parameter sensed by another digital field sensor.

13. An apparatus as defined in claim 11 further comprising a reference sensor plugged into said socket.

14. An apparatus as defined in claim 11 wherein said apparatus is operative to instruct the sensor to generate a digital signal conveying said value as a measure of the level of the parameter, and said digital communication circuit is operative to receive said digital signal and to communicate said value conveyed by said digital signal to said processor, for said processor to calculate said calibration information based on both the level of the parameter as indicated by said reference sensor and said value.

15. An apparatus as defined in claim 11 further comprising an electrically erasable memory device connected to said processor and operative to receive and store device description files, each device description file containing calibration procedure information for a specific sensor model, and said memory device being further operative to send portions of said device description files to said processor when directed to do so by said processor.

16. An apparatus as defined in claim 1 further comprising a reference sensor in operational communication with said processor and operative to send to said processor a reference signal indicative of the level of a parameter sensed by the digital field sensor, for said processor to calculate said calibration information based on both the level of the parameter as indicated by said reference sensor and said value.

17. An apparatus as defined in claim 1 further comprising a handheld housing containing said digital communication circuit and said processor.

18. An electronic circuit for use with a digital field sensor, said circuit comprising:
a digital communication circuit operative to output a digital signal indicative of calibration information for the digital field sensor; and
an A/D converter interactive with said digital communication circuit to input an analog signal from the digital field sensor for determination of said calibration information.

19. An apparatus as defined in claim 18 further comprising a handheld housing containing said digital communication circuit and said A/D converter.

20. An apparatus for calibrating a digital field sensor, said apparatus comprising:
a unitary handheld device operative to measure the level of an analog signal generated by the digital field sensor, to measure the actual level of a parameter sensed by the sensor, to calculate calibration information based on both the level of the analog signal and the actual level of the sensed parameter, and to send to the sensor a digital signal indicative of said calibration information.

21. An apparatus as defined in claim 20 further operative to receive and store device description files, each device description file containing calibration procedure information for a specific sensor model.
